(19) United States
(12) Patent Application Publication
(10) Pub. No.: US 2021/0097521 A1
(43) Pub. Date: Apr. 1, 2021

(54) ELECTRONIC DEVICE AND COMPUTERIZED METHOD FOR OFFLINE PAYMENT TRANSFER

(71) Applicant: MASTERCARD INTERNATIONAL INCORPORATED, PURCHASE, NY (US)

(72) Inventors: Rajeev Kumar, Uttar Pradesh (IN); Vijay Kasul, Telemgana (IN)

(21) Appl. No.: 16/995,290

(22) Filed: Aug. 17, 2020

(30) Foreign Application Priority Data
Sep. 26, 2019 (SG) 10201908975W

(51) Int. Cl. G06Q 20/32; H04W 76/14; G06Q 20/36

(52) U.S. Cl. CPC G06Q 20/325; G06Q 20/36; H04W 76/14

(57) ABSTRACT

The present disclosure generally relates to offline payment transfer. A first electronic device monitors its connectivity to a wide area network and determines it is in the offline mode if it is disconnected from the wide area network. The first electronic device then activates a first offline wallet stored on the first electronic device. The first electronic device establishes a local area network connection with a second electronic device also in the offline mode, the second electronic device having a second offline wallet stored thereon. Payment data is communicated between the first and second electronic devices via the local area network connection. The payment data comprises a payment amount for transfer between the first and second offline wallets. The first and second electronic devices update the first and second offline wallets in response to said transfer of the payment amount.

### CROSS-REFERENCE TO RELATED APPLICATION

This application claims the benefit of, and priority to, Singapore Patent Application No. 10201908975W filed on Sep. 26, 2019. The entire disclosure of the above application is incorporated herein by reference.

### FIELD

The present disclosure generally relates to an offline payment transfer. Particularly, the present disclosure describes various embodiments of an electronic device and a computerized method for payment transfer in an offline mode wherein the electronic device is disconnected from a wide area network.

### BACKGROUND

This section provides background information related to the present disclosure which is not necessarily prior art.

Transactions and payments are increasingly being performed using cashless payment modes in place of conventional cash. Cashless payment modes include payment cards, such as credit cards. Users with electronic devices, such as mobile phones, may install software or mobile applications that function as a digital or mobile wallet for performing transactions and making payments. The digital wallet may be linked to a bank account or stored with some monetary value. In order to perform transactions and make payments, the mobile phone must be connected to the wide area network, e.g., the Internet, for communication with the payment network to process the transactions and payments. It is thus necessary for the electronic device to be in an online mode before the transactions and payments be made. As such, the digital wallet on the electronic device cannot be used in an offline mode, such as in remote areas where there is a lack of telecommunications infrastructure and/or connectivity to the Internet.

United States Patent Publication 20180232732 describes an offline transaction system and method. In the offline mode, a payer device is communicative with a payee device via a local connection which is a direct point-to-point communication channel. The payer device generates a transaction request including the transaction amount, and the payee device generates a transaction confirmation including the transaction amount. The transaction amount may be shared between the devices via the local connection or manually entered by the payer and payee. However, the transaction is only processed once both the payer and payee devices have returned to the online mode. There is no actual transfer of the transaction amount from the payer device to the payee device while in the offline mode. The offline transaction system and method described in US 20180232732 would not be suitable for offline payment transfer in remote areas, as connectivity to the Internet is still required in order to complete the transaction processing.

Therefore, in order to address or alleviate at least one of the aforementioned problems and/or disadvantages, there is a need to provide an improved electronic device and computerized method for offline payment transfer.

### SUMMARY

This section provides a general summary of the disclosure, and is not a comprehensive disclosure of its full scope or all of its features. Aspects and embodiments of the disclosure are set out in the accompanying claims.

According to an aspect of the present disclosure, there is a first electronic device, a computerized method, a non-transitory computer-readable storage medium comprising instructions for payment transfer in an offline mode, and a computerized method for installing a software application to enable payment transfer in the offline mode. The first electronic device is operative by a first user and comprises a processor for performing the method. The method for payment transfer in the offline mode comprises: monitoring connectivity of the first electronic device to a wide area network; determining that the first electronic device is in the offline mode if the first electronic device is disconnected from the wide area network; activating a first offline wallet stored on the first electronic device in response to determining that the first electronic device is in the offline mode; establishing a local area network connection with a second electronic device in the offline mode, the second electronic device having a second offline wallet stored thereon; communicating payment data between the first electronic device and the second electronic device via the local area network connection, the payment data comprising a payment amount for transfer between the first offline wallet and the second offline wallet; and updating the first offline wallet in response to said transfer of the payment amount with the second offline wallet.

An electronic device and computerized method for offline payment transfer according to the present disclosure are thus disclosed herein. Various features, aspects, and advantages of the present disclosure will become more apparent from the following detailed description of the embodiments of the present disclosure, by way of non-limiting examples only, along with the accompanying drawings briefly described below.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of an electronic system for facilitating payment transfer in an offline mode, in accordance with embodiments of the present disclosure.

FIG. 2 is a flowchart illustration of a computerized method implemented on a first electronic device for payment transfer in the offline mode, in accordance with embodiments of the present disclosure.

FIG. 3 is a flowchart illustration of a registration process to perform offline payment transfers, in accordance with embodiments of the present disclosure.

FIGS. 4 and 5 are flowchart illustrations of computerized methods implemented on a payer device and a payee device for payment transfer there between in the offline mode, in accordance with embodiments of the present disclosure.

FIG. 6 is a block diagram illustration of the technical architecture of an electronic device, in accordance with embodiments of the present disclosure.

Corresponding reference numerals indicate corresponding parts throughout the several views of the drawings.

### DETAILED DESCRIPTION

Embodiments will be described, by way of example only, with reference to the drawings. The description and specific examples included herein are intended for purposes of illustration only and are not intended to limit the scope of the present disclosure.

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. For purposes of brevity and clarity, descriptions of embodiments of the present disclosure are directed to an electronic device and computerized method for offline payment transfer, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e., a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

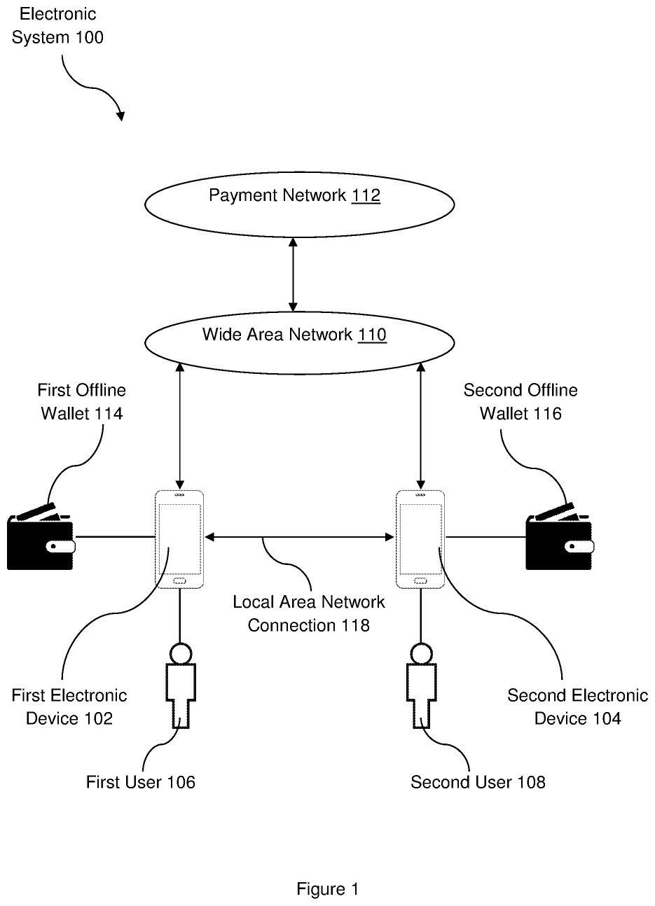

In representative or exemplary embodiments of the present disclosure, there is an electronic or computer system 100 for facilitating payment transfer in an offline mode, as illustrated in FIG. 1. The system 100 includes a first electronic device 102 and a second electronic device 104. The first electronic device 102 is operated by a first user 106, such as a mobile device used by a consumer. The second electronic device 104 is operated by a second user 108, such as a mobile device or payment terminal used by a merchant.

The system 100 includes a communications network also known as a wide area network 110 for facilitating global communications, such as across the Internet. Each of the first electronic device 102 and the second electronic device 104 is connective to the wide area network 110 and connectivity to the wide area network 110 enables the first electronic device 102 and the second electronic device 104 to connect to the Internet for online communications with other electronic/computer devices connected to the wide area network 110. Additionally, the system 100 includes a payment network 112 for processing payments of online transactions. For example, the first user 106 may use the first electronic device 102 to perform an online transaction at an online merchant platform for purchasing some merchandise. The first electronic device 102 is communicative with the online merchant platform via the wide area network 110, and payment of the online transaction is processed by the payment network 112.

However, there are situations where the first electronic device 102 and the second electronic device 104 are disconnected from the wide area network 110. For example, the first user 106 and the second user 108 may be located in a rural or remote area where there is no or limited connectivity to the wide area network 110 or Internet, resulting in the first electronic device 102 and the second electronic device 104 being unable to connect to the wide area network 110. In absence of connectivity to the wide area network 110, the first electronic device 102 and the second electronic device 104 are in the offline mode and are unable to perform online transactions nor make online payment transfers processed by the payment network 112. In order to facilitate payment in absence of connectivity to the wide area network 110, each of the first electronic device 102 and the second electronic device 104 is configured for payment transfer between them in the offline mode.

A software or mobile application is installed and executable on the first electronic device 102 and the second electronic device 104 for performing the offline payment transfer. The application provides an offline wallet stored on the respective electronic device, wherein the offline wallet has a stored value or funds specifically for payment transfer in the offline mode. A first offline wallet 114 is stored on the first electronic device 102 and a second offline wallet 116 is stored on the second electronic device 104. The first offline wallet 114 and the second offline wallet 116 could also be used for subsequent offline transactions or payment transfers in the offline mode.

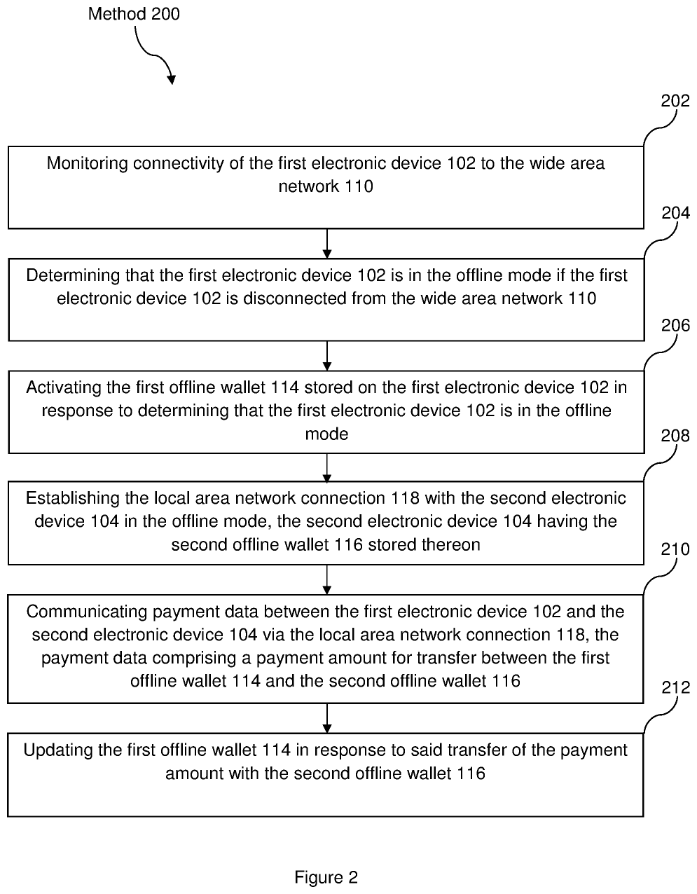

Further with reference to FIG. 2, there is shown a computer-implemented or computerized method 200 implemented on and performed by the first electronic device 102 for payment transfer in the offline mode, such as for offline payment transfer with the second electronic device 104.

In a step 202 of the method 200, the first electronic device 102 monitors connectivity of the first electronic device 102 to the wide area network 110. This would determine if the first electronic device 102 is connected to or disconnected from the wide area network 110. A step 204 determines that the first electronic device 102 is in the offline mode if the first electronic device 102 is disconnected from the wide area network 110. In a step 206, the first electronic device 102 activates the first offline wallet 114 in response to determining that the first electronic device 102 is in the offline mode. In a step 208, the first electronic device 102 establishes a local area network connection 118 with the second electronic device 104 also in the offline mode. The local area network connection 118 is a separate communication channel from the wide area network 110, and may be based on various wireless/contactless local communication protocols, such as near field communication (NFC) and Bluetooth.

In a step 210, the first electronic device 102 communicates payment data between the first electronic device 102 and the second electronic device 104 via the local area network connection 118. The payment data includes a payment amount for transfer between the first offline wallet 114 and the second offline wallet 116. In a step 212, the first electronic device 102 updates the first offline wallet 114 in response to said transfer of the payment amount with the second offline wallet 116. For example, after the first user 106 transfers the payment amount to the second user 108, the payment amount is deducted from the stored value of the first offline wallet 114. Similarly, the payment amount is added to the stored value of the second offline wallet 116.

Accordingly, the first user 106 and the second user 108 can perform a payment transfer between the first electronic device 102 and the second electronic device 104 in the offline mode. For example, the first electronic device 102 operated by a consumer makes an offline payment transfer to the second electronic device 104 operated by a merchant for payment of a retail transaction. The payment transfer is performed and completed when the first electronic device 102 and the second electronic device 104 are in the offline mode, which can happen in remote areas where there is lack of telecommunications infrastructure and/or connectivity to the Internet, without requiring concurrent or subsequent connectivity to the payment network 112 to process the payment transfer. After the payment transfer is completed, the balance stored values in the respective offline wallets 114 and 116 may be subsequently used for other offline payment transfers. Hence, the first user 106 and the second user 108 can perform subsequent offline payment transactions and the updated offline balances may be used for the subsequent offline payment transactions.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

As used herein, the terms “a” and “an” are defined as one or more than one. The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “component”, “module,” “system”, “apparatus”, “interface”, and the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component/module. One or more components/modules may reside within a process and/or thread of execution. A component/module may be localized on one computer and/or distributed among a plurality of computers.

While various terms as used in representative or exemplary embodiments of the present disclosure are defined herein, the definitions of these terms are not intended to be limited as such and are in addition to their plain meanings according to standard English dictionaries.

In various embodiments of the present disclosure, the electronic system 100 includes the first electronic device 102 and the second electronic device 104 payment transfer there between in the offline mode. The first electronic device 102 is operated by the first user 106, such as a consumer, and the second electronic device 104 is operated by the second user 108, such as a merchant. The system 100 further includes the payment network 112 processing payments of online transactions, such as those performed at an online merchant platform for purchasing merchandise or withdrawal transactions at ATMs. The first electronic device 102, the second electronic device 104, and entities on the payment network 112 are communicable with one another through the wide area network 110. Specifically, each of the first electronic device 102 and the second electronic device 104 is connective to the wide area network 110 in an online mode unless there are problems with the connectivity, which would result in disconnection from the wide area network 110 and the first electronic device 102/the second electronic device 104 entering the offline mode.

The payment network 112 is a network of various financial/payment entities, such as issuer and acquirer banks, and which is operated by an intermediary entity. Typically, the intermediary entity is a card association, such as a credit card association, that facilitates communications between acquirer banks and issuer banks to authorize fund transactions. The payment network 112 settles the transactions between various acquirer banks and issuer banks, when payment instruments, such as credit cards, are used for payment of transactions. Some examples of the payment network 112 include the United Payments Interface (UPI) in India and the Banknet payment network operated by Mastercard®. It will be appreciated that payment of the transactions are processed by the payment network 112 in a standard manner across the payment network 112, involving entities such as the acquirer banks, issuer banks and other intermediaries.

Each of the first user 106 and the second user 108 is an account holder of a financial account, such as current account, savings account, trading account, or any account associated with a payment instrument. In many embodiments, the financial account is a bank account maintained by a financial institution, such as an issuer bank or acquirer bank. The financial account is linked to the payment instrument and thus the payment instrument stores identification information of the account. The payment instrument may be a payment card and the account identification information may be stored in the form of an electronic chip or a machine-readable magnetic strip embedded in the payment card. The account identification information may include an account number and the name of the account holder. The payment card has a unique identifier, an expiry date, security data, and type.

The payment instrument generally refers to any suitable cashless payment mechanism, such as payment cards or transaction cards, which the first user 106/second user 108 may use to perform transactions, such as deposits and withdrawals, credit transfers, merchandise purchase, payment transactions, and the like. In some embodiments, the payment instrument is a physical card, such as credit card, debit card, membership card, promotional card, contactless card, charge card, frequent flyer card, gift card, prepaid card, or the like. The payment instrument may be radio frequency identification (RFID) or near field communication (NFC) enabled for performing contactless payment transactions. In some other embodiments, the payment instrument is stored electronically in memory of an electronic device, such as on an application or digital wallet resident or operative on the first electronic device 102/second electronic device 104. The first electronic device 102/second electronic device 104 may be a mobile device, mobile phone, smartphone, personal digital assistant (PDA), key fob, transponder device, NFC-enabled device, tablet, phablet, laptop, computer, merchant billing machine, payment terminal, other communication device, or the like.

The wide area network 110 is a medium or environment through which content, notifications, and/or messages are communicated among various entities, including the first electronic device 102, second electronic device 104, and entities on the payment network 112. The wide area network 110 enables connectivity to the Internet and one or more other communication networks, including, but not limited to, virtual private networks, local area networks, metropolitan area networks, satellite networks, fiber optic networks, coaxial cable networks, and any combination thereof. Various entities on the wide area network 110 connect to the wide area network 110 in accordance with various wired and wireless communication protocols, such as Transmission Control Protocol/Internet Protocol (TCP/IP), User Datagram Protocol (UDP), 2nd to 5th Generation (2G to 5G) communication protocols, Long Term Evolution (LTE) communication protocols, and any combination thereof. Each of the first electronic device 102, second electronic device 104, and entities on the payment network 112 includes a data communication or transceiver module to communicate and transmit/receive data over the wide area network 110. Some non-limiting examples of a transceiver module include an antenna module, a radio frequency transceiver module, a wireless transceiver module, an Ethernet port, a Universal Serial Bus (USB) port, or any other module/component/device configured for transmitting and receiving data.

In the online mode, the first electronic device 102 and the second electronic device 104 are connected to the wide area network 110 and consequently to the Internet, and thus are able to perform online transactions with online payments processed by the payment network 112. However, there are situations where the first electronic device 102 and the second electronic device 104 are disconnected from the wide area network 110. For example, the first user 106 and the second user 108 may be located in a rural or remote area where there is no or limited connectivity to the wide area network 110 or Internet, such as due to lack of or inadequate telecommunications infrastructure in the area. There may also be poor telecommunication signal strength, network availability issues, and/or problems with the telecommunications operator for the first electronic device 102/second electronic device 104. These problems would result in the first electronic device 102 and the second electronic device 104 being unable to connect to the wide area network 110. In absence of connectivity to the wide area network 110, the first electronic device 102 and the second electronic device 104 are in the offline mode and are unable to perform online transactions nor make online payments.

In order to facilitate payment in absence of connectivity to the wide area network 110, each of the first electronic device 102 and the second electronic device 104 is configured for payment transfer between them in the offline mode. As described above, a software or mobile application is installed and executable on the first electronic device 102 and the second electronic device 104 for performing the offline payment transfer. The application may be provided by a financial institution of the financial account held by the respective first user 106 and the second user 108, such as the issuer bank for a consumer's account and the acquirer bank for a merchant's account. The application may otherwise be provided by a third-party service provider, such as the intermediary entity operating the payment network 112 or a digital wallet service provider. While the first electronic device 102 and the second electronic device 104 may be installed with different applications provided by different providers for performing the offline payment transfers, these applications should adopt a common standard and/or application programming interface to mitigate risk of erroneous or even fraudulent payment transfers in the offline mode.

As described above, the method 200 is implemented on and performed by the first electronic device 102 for payment transfer in the offline mode. The first electronic device 102 includes various modules/components for performing various operations or steps of the method 200, such as for offline payment transfer with the second electronic device 104. It will be appreciated that the method 200 may also be implemented on and performed by the second electronic device 104 for offline payment transfer with the first electronic device 102. Specifically, various operations or steps of the method 200 and various modules/components for performing these operations or steps relating to the first electronic device 102 apply similarly or analogously to the second electronic device 104.

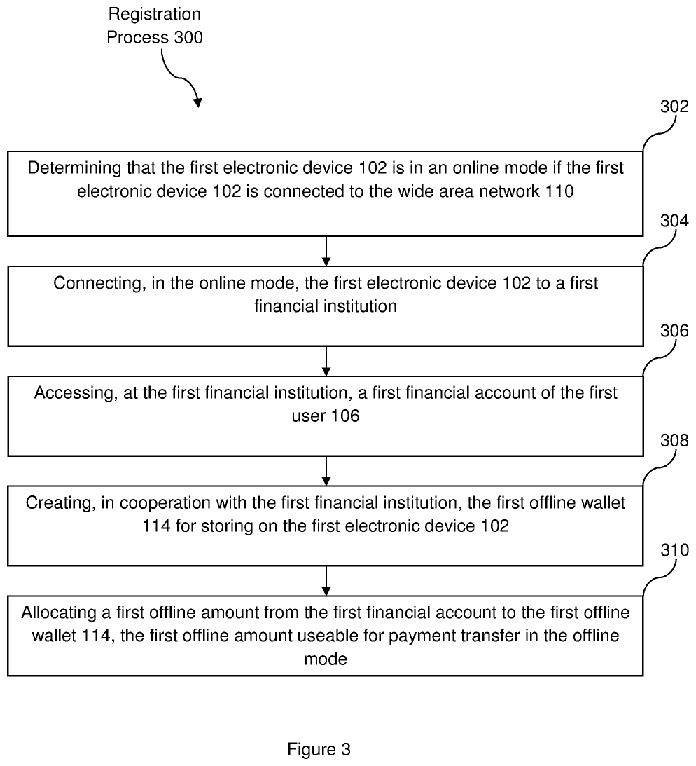

A registration process 300 is performed by the first user 106/second user 108 using the application installed on the first electronic device 102/second electronic device 104 in order for the application to be able to perform offline payment transfers. Notably, the registration process 300 is performed in the online mode wherein the first electronic device 102/second electronic device 104 is connected to the wide area network 110. Various steps of the registration process 300 are described below for the first user 106 and the first electronic device 102 with reference to FIG. 3.

The first user 106 executes the application on the first electronic device 102 to perform the registration process 300. The application may require the first user 106 to login with predefined user credentials or to set up new credentials for first-time usage. A step 302 of the registration process 300 determines that the first electronic device 102 is in the online mode if the first electronic device 102 is connected to the wide area network 110. In a step 304, the first electronic device 102 connects, in the online mode, to a first financial institution providing the application installed on the first electronic device 102. Notably, the first financial institution is part of the payment network 112 and the first electronic device 102 is connected thereto via the payment network 112. In a step 306, the first electronic device 102 accesses, at the first financial institution, a first financial account of the first user 106. For example, the first electronic device 102 connects to and accesses an online interface or platform hosted on a computer system, or server, of the first financial institution, which may be an issuer bank or acquirer bank depending on whether the first user 106 is a consumer or merchant.

In a step 308, the first electronic device 102 creates, in cooperation with the first financial institution, the first offline wallet 114 for storing on the first electronic device 102. For example, the first user 106 initiates a request for configuring the first electronic device 102 to perform offline payment transfers. The first electronic device 102 then communicates the request to the first financial institution. The request includes a first offline amount defined by the first user 106 for allocating to the first offline wallet 114. The first financial institution receives the request and proceeds to process the request. Process of the request includes authenticating the identity of the first user 106 and may involve authentication security protocols such as, but not limited to, use of predefined passwords, PINs, biometric data, and one-time passwords (OTPs). Processing of the request further includes authorizing the first offline amount to be allocated which includes verifying that the first financial account has sufficient funds for the first offline amount. The request may optionally include a maximum value defined by the first user 106 for capping the stored value of the first offline wallet 114. The first financial institution may optionally cap the first offline amount and/or require the first financial account to have a minimum balance after allocation of the first offline amount.

Upon processing and approval of the request, the first financial institution communicates a request approval message to the first electronic device 102. In a step 310, the first electronic device 102 allocates the first offline amount from the first financial account to the first offline wallet 114. The first offline amount represents the stored value or funds in the first offline wallet 114 and is useable specifically for payment transfer in the offline mode. The first offline wallet 114 thus cannot be used for online transactions or payments, but the remaining balance in the first financial account after said allocation of the first offline amount is useable for payment transfer in the online mode.

Although the registration process 300 is described for the first user 106 and the first electronic device 102, it will be appreciated that various aspects of the registration process 300 apply similarly or analogously for the second user 108 and the second electronic device 104 and are not further described for purpose of brevity. Accordingly, the registration process 300 is performed on each of the first electronic device 102 and the second electronic device 104 for creating the first offline wallet 114 and the second offline wallet 116 stored thereon, respectively, to perform offline payment transfers.

In some embodiments, the first electronic device 102 is a payer device, the first user 106 is a consumer, the second electronic device 104 is a payee device, the second user 108 is a merchant. Alternatively, the first electronic device 102 is the payee device, the first user 106 is the merchant, the second electronic device 104 is the payer device, and the second user 108 is the merchant. The payer device and the payee device respectively store a payer offline wallet and a payee offline wallet, such as the first offline wallet 114 and the second offline wallet 116, configured for offline payment transfer. The offline payment transfer may be for a retail transaction between the consumer and merchant. In some embodiments, both the first user 106 and the second user 108 are consumers or individual users, or both are merchants, such that the offline payment transfer between the payer device and the payee device represents a peer-to-peer (P2P) payment transfer between consumers or between merchants in the offline mode.

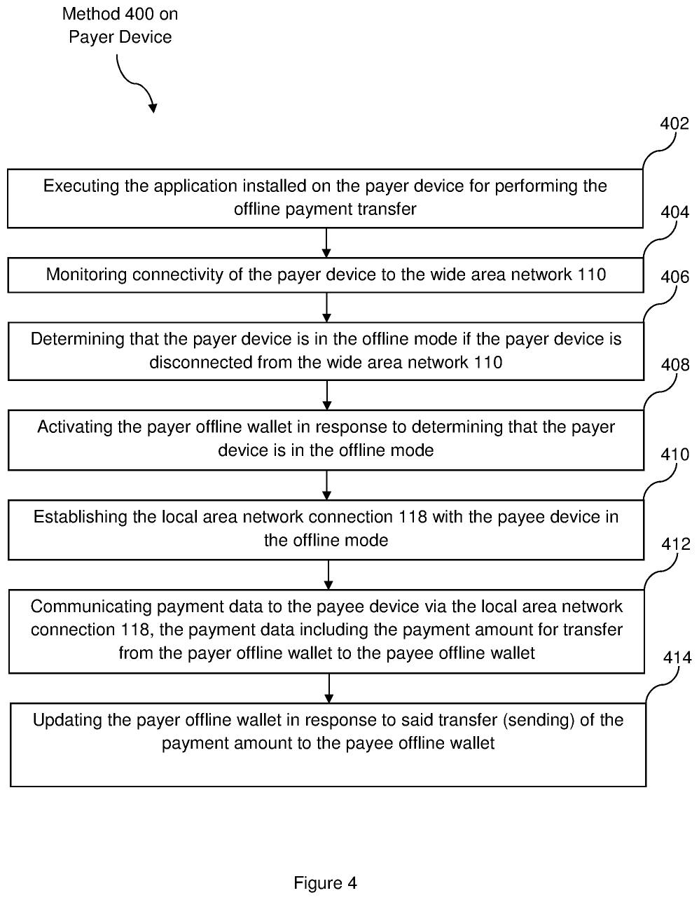

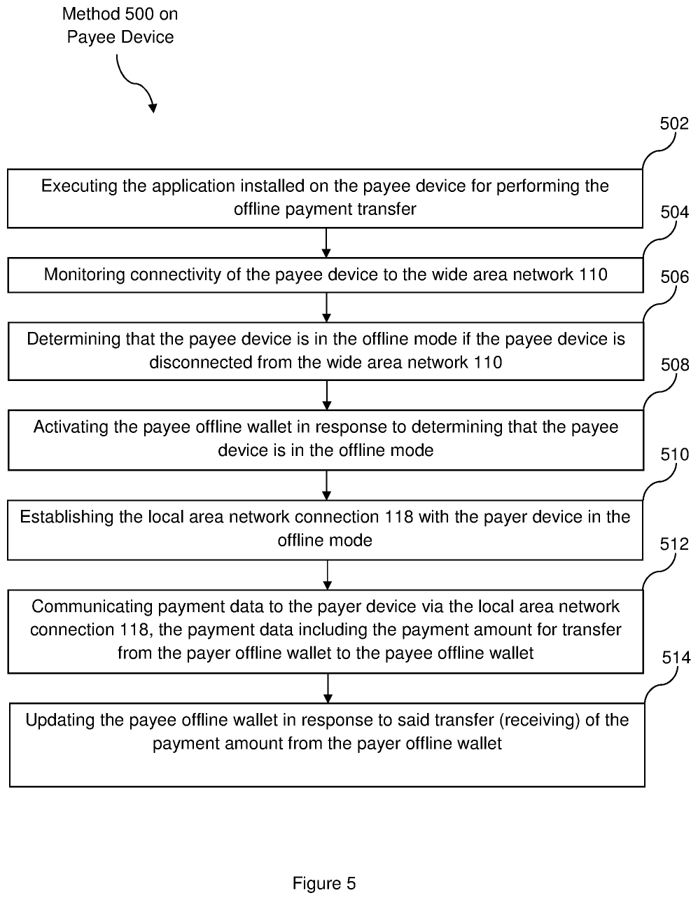

In many embodiments, there is a payer operating a payer device and a payee operating a payee device, both the payer device and the payee device are configured for performing offline payment transfers between them. With reference to FIG. 4 and FIG. 5, there is a computerized method 400 implemented on the payer device and a corresponding computerized method 500 implemented on the payee device for performing a payment transfer in the offline mode.

In a step 402 of the method 400, the payer executes the application installed on the payer device for performing the offline payment transfer. Correspondingly, in a step 502 of the method 500, the payee executes the application installed on the payee device for performing the offline payment transfer. The applications may require the payer and payee to login with predefined user credentials set up during the registration process 300. In a step 404, the payer device monitors connectivity of the payer device to the wide area network 110. In a step 504, the payee device monitors connectivity of the payee device to the wide area network 110. The steps 404 and 504 determine if the payer device and the payee device are connected to or disconnected from the wide area network 110, thus determining if they are in the online or offline mode.

In the online mode, the payer would be able to access the payer's financial account on the application to perform online transactions and payments, but not if the payer device is in the offline mode. In a step 406, the payer device determines that it is in the offline mode if the payer device is disconnected from the wide area network 110. In a step 506, the payee device determines that it is in the offline mode if the payee device is disconnected from the wide area network 110. In a step 408, the payer device activates the payer offline wallet in response to determining that the payer device is in the offline mode. In a step 508, the payee device activates the payee offline wallet in response to determining that the payee device is in the offline mode. Both the payer offline wallet and the payee offline wallet are thus activated for sending and receiving the offline payment transfer, respectively.

The payer offline wallet is allocated with a payer offline amount from the payer financial account. The payer offline amount represents the stored value or funds in the payer offline wallet and is useable specifically for offline payment transfer. Only the balance in the payer financial account can be used for online payment transfers, but not the payer offline wallet which is specifically configured for offline payment transfers. However, if the payer device subsequently reconnects to the wide area network 110, the payer device deactivates the payer offline wallet in response to determining that the payer device is connected to the wide area network 110 and has returned to the online mode. Thus, once the payer device is in the online mode, the payer offline wallet can no longer be used for offline payment transfers, but the payer financial account can be used for online payment transfers.

In steps 410 and 510, the payer device and the payee device are in the offline mode and establish the local area network connection 118 with each other. As stated above, the local area network connection 118 is a separate communication channel from the wide area network 110. The local area network connection may mean a direct point-to-point connection or communication channel between the payer device and the payee device, or may mean a connection within a local area network which the payer device and the payee device are part of, such as a local Wi-Fi network or a virtual private network. The local area network connection thus enables the payer device and the payee device to communicate with each other via an appropriate mechanism, such as via wired or wireless connections. For example, the local area network connection 118 may be wired or based on various wireless/contactless local communication protocols, such as short-range wireless communications. Short-range wireless communications may be based on P2P technologies, such as Bluetooth and NFC, or local network technologies, such as Wi-Fi and mesh networking.

In some embodiments, the payer device and the payee device perform a verification process to verify the identities of the devices, thus ensuring that the local area network connection 118 is established between the correct payer and payee devices. The verification process may require the payer device and the payee device to determine and compare respective authorization codes. The local area network connection 118 is established if the authorization codes match. As an example, each of the payer device and the payee device may generate and display an authorization code which is communicated to the user of the other device. The payer/payee then enters the authorization code obtained from the payee/payer device into the payer device/payee device, respectively. The payer device and the payee device then exchange the authorization codes to ensure that they match, thus verifying the identities of the devices and establishing the local area network connection 118 between them.

In some embodiments, the local area network connection 118 is based on Wi-Fi technology. In one embodiment, the payee device is connected to a Wi-Fi network established by a Wi-Fi access point. For example, the payee device is operated by a merchant and the merchant has set up a router as the Wi-Fi access point at the merchant premises for the Wi-Fi network. In another embodiment, the payee device is set up as the Wi-Fi access point or hotspot for the Wi-Fi network. The payer device searches for the payee device on the Wi-Fi network for establishing the local area network connection 118. Specifically, the payer device searches for the service set identifier (SSID) of the Wi-Fi network which the payee device is connected to, and the payer device becomes communicative with the payee device via the Wi-Fi network. It may be possible that the payer device is set up as the Wi-Fi access point and the payee device searches for the payer device on the Wi-Fi network. In another embodiment, the local area network connection is based on Wi-Fi Direct which is a P2P wireless technology for directly pairing and connecting two devices without requiring an access point. At least one of the payer device and the payee device is required to be compliant with Wi-Fi Direct to establish the P2P local area network connection 118. The various types of local area network connection 118 based on Wi-Fi technology described above may optionally adopt various Wi-Fi security/encryption protocols such as, but not limited to, Wired Equivalent Privacy (WEP), Wi-Fi Protected Access (WPA), Wi-Fi Protected Access II (WPA2), Temporal Key Integrity Protocol (TKIP), and Advanced Encryption Standard (AES).

In some embodiments, the local area network connection 118 is based on Bluetooth technology. The payer device and the payee device must be paired together to establish the Bluetooth connection for communication of data between them. In one embodiment, the payee device is set to a discoverable mode and allows other devices in the vicinity, or within the Bluetooth signal range of the payee device, to detect its presence and attempt to establish a Bluetooth pairing. The payer device then searches for the payee device to establish the Bluetooth pairing. The payee device may have an authorization code or Bluetooth passkey that is given to the payer for entering on the payer device. The passkey may be predefined by the payee device or determined by the payee. The payee device then communicates the passkey to the payer device. The payer device compares the communicated passkey with the entered passkey, and if both match, a trusted pair is formed and the Bluetooth local area network connection 118 is established. It may be possible that the payer device is set to a discoverable mode and the payee device searches for the payer device to establish the Bluetooth pairing.

In some embodiments, the local area network connection 118 is based on NFC technology. NFC is available on many mobile phones/smartphones and is commonly used in contactless payment systems, such as by digitizing a payment instrument in a digital wallet stored on a mobile phone. One of the payer device and the payee device has an NFC tag and the other has an NFC reader device. The NFC local area network connection 118 is established when the NFC tag is read by the NFC reader device once the NFC tag is within the effective range of the NFC reader device. The effective range may vary from about less than 2 inches to about less than 1 foot. The NFC tag may be a passive one which has no battery, or an active one with an integrated battery.

In some embodiments, the local area network connection 118 is based on radio frequency identification (RFID) technology which is similar to NFC. One of the payer device and the payee device has an RFID tag and the other has an RFID reader device. The effective range of the RFID reader device to read the RFID tag may vary from a few centimeters to a few feet, depending on the strength of the RFID reader device. In some embodiments, the local area network connection 118 is based on infrared technology which allows communication of data through light emitting diodes (LEDs) and/or laser. An example of the infrared local area network connection 118 is based on the Infrared Data Association's standard known as IrDA.

In some embodiments, the local area network connection 118 is established using an optical code, such as a Quick Response (QR) code. For example, the payer device displays a QR code for scanning by a camera of the payee device. The QR code is generated specifically for an offline payment transfer session and is embedded with payment data for the offline payment transfer. The payee device scans the QR code to establish the local area network connection 118 and receives the payment data from the payer device. Although QR code is described, it will be appreciated that there are other examples of the optical code, such as, but not limited to, barcode, EZcode, high capacity color barcode, ShotCode, MaxiCode, GTIN12 code, GTIN-13 code, and Aztec code.

In some embodiments, the local area network connection 118 is based on a mesh network, also known as a many-to-many network. Various mesh networking technologies can be adopted, such as, but not limited to, Bluetooth Low-Energy (BLE), Zigbee, Z-Wave, 6LoWPAN, and the like. For example, a Zigbee mesh network is suitable for use in an isolated location, such as where there is limited or no connectivity to the wide area network 110 or Internet, and is thus suitable for facilitating payments in the offline mode as described herein. In some embodiments, the local area network connection 118 is wired. For example, a communication cable, such as a Universal Serial Bus (USB) cable, physically connects the payer device and the payee device together. The communication cable forms the local area network connection 118 and the payment data is communicable via the communication cable.

Furthermore, in a step 412 of the method 400, the payer device communicates payment data to the payee device via the local area network connection 118. Correspondingly, in a step 512 of the method 500, the payee device receives the payment data from the payer device via the local area network connection 118. The payment data includes a payment amount for transfer from the payer offline wallet to the payee offline wallet. The payment amount is input by the payer on the payer device and may represent the price of merchandise purchased by the payer (e.g., consumer) from the payee (e.g., merchant).

The payment data may further include identification data of at least the payer, payer device, and payer offline wallet. The identification data may be useful for the payee device to maintain a transaction history of offline payment transfers from payer devices. The identification data may include, but is not limited to, a name of the payer, a phone number of the payer and associated with the payer device, and a hardware identifier of the payer device. The payment data may include any other additional data required to perform the offline payment transfer, such as, but not limited to, payer authentication data, a shared secret, encryption logic, or the like.

In some embodiments, the payment data is encrypted before communication via the local area network connection 118. Specifically, the payer device encrypts the payment data and the encrypted payment data is decryptable by the payee device. In one embodiment, encryption/decryption of the payment data is based on public-key or asymmetric cryptography which is a cryptographic system that uses an asymmetric or public-private key pair, i.e., a public key that is shared to others and a private key known only to the owner. In one example, the payer device encrypts the payment data using the payer private key and shares the payer public key with the payee device. The payee device receives the encrypted payment data and decrypts it using the payer public key. In another example, the payee device shares the payee public key with the payer device. The payer device encrypts the payment data using the payee public key. The payee device receives the encrypted payment data and decrypts it using the payee private key. It will be appreciated that there are other types of encryptions available for encrypting the payment data, as will be readily understood by the skilled person.

In a step 414, the payer device updates the payer offline wallet in response to said transfer (sending) of the payment amount to the payee offline wallet. Correspondingly, in a step 514, the payee device updates the payee offline wallet in response to said transfer (receiving) of the payment amount from the payer offline wallet. Thus, after the payer transfers the payment amount to the payee, the payment amount is deducted from the payer offline amount value in the payer offline wallet, and the payment amount is correspondingly added to the payee offline amount stored in the payee offline wallet. The updated offline amounts in the respective offline wallets may be subsequently used for other offline payment transfers. Updating of the payer offline wallet and the payee offline wallet is performed automatically after the payment data is sent from the payer device to the payee device. Transfer of the payment amount can thus be performed and completed automatically within an offline environment where both devices are in the offline mode, without requiring concurrent or subsequent connectivity to the wide area network 110, such as to cooperate with the payment network 112 to process the payment transfer. Communication with the payment network 112 is unnecessary to complete the payment transfer which is performed entirely in the offline environment, unlike the offline transaction system and method described in US 20180232732.

Offline payment transfers as described in the methods 400 and 500 can be performed in remote areas where there is no or limited connectivity to the wide area network 110 or Internet. The offline payment transfers do not need to rely on such connectivity to the Internet or telecom/data network to be performed, enabling P2P payment transfers entirely in the offline environment. Such offline payment transfers help to address the problem of financial inclusion by allowing people living in such remote areas to be able to utilize financial/payment services. In some embodiments, the payer leaves the remote area and goes to another area where there is connectivity to the wide area network 110 and Internet. The payer device then deactivates the payer offline wallet in response to determining that payer device is connected to the wide area network 110. The payer offline wallet is deactivated to prevent the payer from using it for offline payment transfers, since the payer device has returned to the online mode and the payer offline amount stored in the payer offline wallet is useable specifically for offline payment transfers. The payer can use the payer device in the online mode to access the balance in the payer financial account for performing online transactions and making online payment transfers.

In some embodiments using the first electronic device 102 as an example, the first offline amount stored in the first offline wallet 114 is useable for both sending and receiving of payment amounts in the offline mode. Specifically, for an offline payment transfer from the first electronic device 102 to the second electronic device 104, the payment amount is deducted from the first offline amount. Similarly, for an offline payment transfer from the second electronic device 104 to the first electronic device 102, the payment amount is added to the first offline amount. Once the first user 106 has exhausted the first offline amount after a number of offline payment transfers, the first user 106 cannot make further offline payment transfers until the first user 106 has reloaded the first offline wallet 114 with fresh funds from the first financial account. Notably, said reloading of the first offline wallet 114 is done when the first electronic device 102 is in the online mode. The first user 106 may also transfer funds from the first offline wallet 114 to the first financial account in the online mode.

Other than in remote areas with no or limited Internet connectivity, offline payment transfers as described in the methods 400 and 500 may be useful to users who are travelling to a foreign country. The first offline wallet 114 may include a number of currencies, so that the first offline amount can be stored at one or more of these currencies. The currencies of the first offline amount may be defined by the first user 106 during the registration process 300 or at any time when the first electronic device 102 is in the online mode. For example, the first user 106 plans to travel to a foreign country where a foreign currency is used. The first user 106 may not have Internet connectivity in the foreign country, for example if the first electronic device 102 does not have roaming. Before travelling, the first user 106 may allocate part of the first offline amount in the foreign currency, and the remaining in his domestic currency. The first user 106 may even allocate all of the first offline amount in the foreign currency. The part or all of the first offline amount in the foreign currency can be used for offline payment transfers in the foreign currency when the first user 106 is in the foreign country. If the first offline amount has been allocated in the domestic currency, part or all of the first offline amount may be subsequently convertible to the foreign currency. Additionally, the first offline amount may be convertible among the currencies of the first offline wallet 114 when the first electronic device 102 is in the online mode.

In an exemplary scenario, the first user 106 has allocated the first offline amount, e.g., SGD 1000, from the first financial account to the first offline wallet 114 on the first electronic device 102, as described above in the registration process 300. Prior to travelling to a foreign country, the first user 106 has allocated part of the first offline amount in the foreign currency, and the remaining in his domestic currency. For example, the first user 106 has allocated half of the SGD 1000 in the foreign INR currency. This means that the first offline wallet 114 has SGD 500 and the remaining SGD 500 in INR currency (approximately 25,000 INR). The foreign exchange rate is provided by the first financial institution at the time of converting the SGD to INR.

Alternatively, the first user 106 did not do said converting prior to travelling. Upon arrival at the foreign country, the first electronic device 102 detects its location, such as by GPS using a geolocation module thereof which is not dependent on Internet connectivity. Part or all of the first offline amount in the first offline wallet 114 may be automatically converted to the foreign currency upon detection of the location. The first user 106 may be requested to confirm the amount to be converted. However, the foreign exchange rate provided by the first financial institution would be dependent on Internet connectivity so that the first electronic device 102 can receive the foreign exchange rate data from the first financial institution.

At the foreign country, the first user 106 attempts to make a payment to the second user 108. As described above in the methods 400 and 500, the first electronic device 102 interacts with the second electronic device 104 to transfer a payment amount (in the foreign currency) from the first offline wallet 114 to the second offline wallet 116. The payment amount is deducted from the part of the first offline amount that is in the foreign currency, and added to the second offline amount in the second offline wallet 116. In one example, the second user 108 is likely a user or merchant in the foreign country, so the second offline amount is likely in the foreign currency. The payment amount would be added to the second offline amount in the same foreign currency. In another example, the second user 108 is also a fellow traveler in this foreign country and the second offline amount may be in a different domestic currency (e.g., SGD or USD) from the foreign currency. The payment amount may be added to the second offline amount in a separate currency from the domestic currency of the second offline amount.

Although various embodiments described herein relate to the first electronic device 102 and the second electronic device 104 of the system 100, it will be appreciated that the system 100 may include any number of electronic devices for offline payment transfers between the devices. Additionally, it will be appreciated that various aspects of the embodiments described herein from the perspective of the first electronic device 102 and the first user 106 apply similarly or analogously to the second electronic device 104 and the second user 108, and are not further elaborated for purpose of brevity.

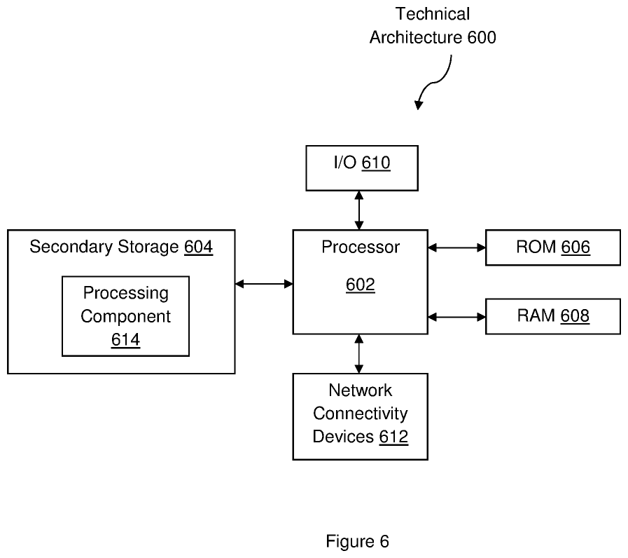

FIG. 6 is a block diagram illustrating an exemplary technical architecture 600 of an electronic device, such as the first electronic device 102 and the second electronic device 104.

The technical architecture 600 includes a processor 602 (also referred to as a central processor unit or CPU) that is in communication with memory devices including secondary storage 604 (such as disk drives or memory cards), read-only memory (ROM) 606, and random-access memory (RAM) 608. The processor 602 may be implemented as one or more CPU chips. Various modules or components for performing various operations or steps of the methods 200/300/400/500 are configured as part of the processor 602 and such operations or steps are performed in response to non-transitory instructions operative or executed by the processor 602. The processor 602 includes suitable logic, circuitry, and/or interfaces to execute such operations or steps. Some non-limiting examples of the processor 602 include an application-specific integrated circuit (ASIC) processor, a reduced instruction set computing (RISC) processor, a complex instruction set computing (CISC) processor, a field-programmable gate array (FPGA), and the like.

The technical architecture 600 further includes input/output (I/O) devices 610, and system connectivity/network devices 612. The secondary storage 604 typically includes one or more memory cards, disk drives, tape drives, or other storage devices and is used for non-volatile storage of data and as an over-flow data storage device if RAM 608 is not large enough to hold all working data. Secondary storage 604 may be used to store programs which are loaded into RAM 608 when such programs are selected for execution.

The secondary storage 604 has a processing component 614 including non-transitory instructions operative by the processor 602 to perform various operations or steps of the methods 200/300/400/500 according to various embodiments of the present disclosure. The ROM 606 is used to store instructions and perhaps data which are read during program execution. The secondary storage 604, the ROM 606, and/or the RAM 608 may be referred to in some contexts as computer-readable storage media and/or non-transitory computer-readable media. Non-transitory computer-readable media includes all computer-readable media, with the sole exception being a transitory propagating signal per se.

The I/O devices 610 may include printers, video monitors, liquid crystal displays (LCDs), plasma displays, touch screen displays, keyboards, keypads, switches, dials, mice, track balls, voice recognizers, card readers, paper tape readers, and/or other known input devices.

The system connectivity/network devices 612 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols, such as code division multiple access (CDMA), global system for mobile communications (GSM), long-term evolution (LTE), worldwide interoperability for microwave access (WiMAX), near field communication (NFC), radio frequency identity (RFID), and/or other air interface protocol radio transceiver cards, and other known system connectivity/network devices. These system connectivity/network devices 612 may enable the processor 602 to communicate with the Internet or one or more intranets. With such a system/network connection, it is contemplated that the processor 602 might receive information from the network, or might output information to the network in the course of performing the operations or steps of the methods 200/300/400/500. Such information, which is often represented as a sequence of instructions to be executed using processor 602, may be received from and outputted to the network, for example, in the form of a computer data signal embodied in a carrier wave.

The processor 602 executes instructions, codes, computer programs, scripts which it accesses from hard disk, floppy disk, optical disk (these various disk-based systems may all be considered secondary storage 604), flash drive, ROM 606, RAM 608, or the system connectivity/network devices 612. While only one processor 602 is shown, multiple processors may be present. Thus, while instructions may be discussed as executed by a processor, the instructions may be executed simultaneously, serially, or otherwise executed by one or multiple processors.

The technical architecture 600 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture 600 to provide the functionality of a number of servers that is not directly bound to the number of computers in the technical architecture 600. In an embodiment, the functionality disclosed above may be provided by executing the application and/or applications in a cloud computing environment. Cloud computing may include providing computing services via a system/network connection using dynamically scalable computing resources. A cloud computing environment may be established by an enterprise and/or may be hired on an as-needed basis from a third-party provider.

It is understood that by programming and/or loading executable instructions onto the technical architecture 600, at least one of the CPU 602, ROM 606, and RAM 608 are changed, transforming the technical architecture 600 in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

Furthermore, various embodiments of the present disclosure may be implemented as a method, apparatus, or article of manufacture using standard programming and/or engineering techniques to produce software, firmware, hardware, or any combination thereof, to control a computer to implement the disclosed embodiments. For instance, various embodiments may be implemented as a computer-readable medium embedded with a computer-executable program, which encompasses a computer program accessible from any computer-readable storage device or storage media. For example, computer-readable media can include, but are not limited to, magnetic storage devices (e.g., hard disk, floppy disk, or magnetic strips), optical discs (e.g., compact disc (CD), digital versatile disc (DVD), or Blu-ray disc), smart cards, flash memory devices (e.g., card, stick, or key drive), and solid state drives/memory devices.

In the foregoing detailed description, embodiments of the present disclosure in relation to an electronic device and computerized method for offline payment transfer are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, and as described, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computerized method for effecting a payment transfer in an offline mode, the method comprising:
monitoring, by a first electronic device of a first user, connectivity of the first electronic device to a wide area network;
determining, by the first electronic device, that the first electronic device is in the offline mode, in response to the first electronic device disconnecting from the wide area network;
activating a first offline wallet stored on the first electronic device in response to determining that the first electronic device is in the offline mode;
establishing, by the first electronic device, a local area network connection with a second electronic device in the offline mode, the second electronic device having a second offline wallet stored thereon;
communicating payment data between the first electronic device and the second electronic device via the local area network connection, the payment data comprising a payment amount for transfer between the first offline wallet and the second offline wallet; and
updating, by the first electronic device, the first offline wallet in response to said transfer of the payment amount with the second offline wallet.

2. The method according to claim 1, further comprising deactivating the first offline wallet in response to determining that the first electronic device is connected to the wide area network.

3. The method according to claim 1, wherein the local area network connection is based on short-range wireless communications.

4. The method according to claim 3, further comprising searching for the second electronic device to establish the local area network connection.

5. The method according to claim 1, wherein the local area network connection is established using an optical code.

6. The method according to claim 1, wherein the payment data further comprises identification data of at least one of the first user, the first electronic device, and the first offline wallet.

7. The method according to claim 1, further comprising encrypting the payment data before communicating the encrypted payment data via the local area network connection.

8. The method according to claim 1, further comprising performing, by the first electronic device, a registration process;
wherein performing the registration process includes:
determining that the first electronic device is in an online mode in response to the first electronic device connecting to the wide area network;
connecting, in the online mode, the first electronic device to a first financial institution;
accessing, at the first financial institution, a first financial account of the first user;
creating, in cooperation with the first financial institution, the first offline wallet for storing on the first electronic device; and
allocating a first offline amount from the first financial account to the first offline wallet, the first offline amount useable for the payment transfer in the offline mode.

9. The method according to claim 8, wherein a remaining balance in the first financial account after said allocation of the first offline amount is useable for payment transfer in the online mode.

10. The method according to claim 8, wherein the first offline amount is stored in a number of currencies.

11. The method according to claim 8, wherein at least a part of the first offline amount is convertible to a foreign currency for offline payment transfer in the foreign currency.

12. An electronic device operative by a user for payment transfer in an offline mode, the electronic device comprising a processor configured to:
monitor connectivity of the electronic device to a wide area network;
determine that the first electronic device is in the offline mode, when the electronic device is disconnected from the wide area network;
activate an offline wallet stored on the electronic device in response to a determination that the electronic device is in the offline mode;
establish a local area network connection with a second electronic device in the offline mode, the second electronic device having an offline wallet stored thereon;
communicate payment data between the electronic device and the second electronic device via the local area network connection, the payment data comprising a payment amount for transfer between the offline wallet of the electronic device and the offline wallet of the second electronic device; and
update the offline wallet of the electronic device in response to said transfer of the payment amount with the offline wallet of the second electronic device.

13. The electronic device according to claim 12, wherein the processor is further configured to deactivate the offline wallet of the electronic device in response to a determination that the electronic device is connected to the wide area network.

14. The electronic device according to claim 12, wherein the local area network connection is based on one of Bluetooth, NFC, and Wi-Fi.

15. The electronic device according to claim 12, wherein the payment data further comprises identification data of at least one of the user, the electronic device, and the offline wallet of the electronic device.

16. The electronic device according to claim 12, wherein the processor is further configured to encrypt the payment data before the payment data is communicated via the local area network connection.

17. The electronic device according to claim 16, wherein the processor is configured to encrypt the payment data based on an asymmetric key pair.

18. The electronic device according to claim 12, wherein the processor is further configured, in order to register the electronic device for use in the payment transfer in the offline mode, to:
determine that the electronic device is in an online mode when the electronic device is connected to the wide area network;
connect, in the online mode, to a financial institution;
access, at the financial institution, a financial account of the user;
create, in cooperation with the financial institution, the offline wallet of the electronic device for storing on the electronic device; and
allocate an offline amount from the financial account to the offline wallet of the electronic device, the offline amount useable for the payment transfer in the offline mode.

19. A non-transitory computer-readable storage medium storing computer-readable instructions that, when executed by a processor of an electronic device, cause the processor to:
monitor connectivity of the electronic device to a wide area network;
determine that the electronic device is in an offline mode, when the electronic device is disconnected from the wide area network;
activate an offline wallet stored on the electronic device in response to a determination that the electronic device is in the offline mode;
establish a local area network connection with a second electronic device in the offline mode, the second electronic device having an offline wallet stored thereon;
communicate payment data to the second electronic device via the local area network connection, the payment data comprising a payment amount for transfer between the offline wallet of the electronic device and the offline wallet of the second electronic device; and
update the offline wallet of the electronic device in response to said transfer of the payment amount with the offline wallet of the second electronic device.

20. (canceled)
